(19) United States
(12) Patent Application Publication
(10) Pub. No.: US 2026/0236864 A1
(43) Pub. Date: Aug. 13, 2026

(54) MINIMIZING EMISSIONS IN OIL AND GAS FIELD DEVELOPMENT PLANNING

(71) Applicant: SCHLUMBERGER TECHNOLOGY CORPORATION, Sugar Land, TX (US)

(72) Inventors: Kassem GHORAYEB, Abu Dhabi (AE); Hussein Hayek, Abingdon (GB); Ahmad Harb, Abingdon (GB); Aya Khalaf, Beirut (LB); Mohammad Haj Hussein, Beirut (LB)

(21) Appl. No.: 19/153,622

(22) PCT Filed: Jun. 28, 2024
(86) PCT No.: PCT/US2024/036214

§ 371 Date: Aug. 5, 2025

Related U.S. Application Data
(60) Provisional application No. 63/511,467, filed on Jun. 30, 2023.

(51) Int. Cl. G06Q 10/0631; G06Q 10/0635; G06Q 50/02

(52) U.S. Cl. CPC G06Q 10/06316; G06Q 10/0635; G06Q 50/02

(57) ABSTRACT

The present disclosure describes a method may include receiving input data comprising geological data, an indication of a set of components to be placed in a layout for the site, and an emission cost estimate for each of the set of components. The method may also include defining uncertainty parameters and generating a plurality of planning scenarios to implement based on the components and uncertainty parameters. Additionally, the method may include determining facility placements, well trajectories, pipeline placements, and a net present value for each of the planning scenarios. Further, the method may include calculating a tax credit for each of the planning scenarios, ranking each of the planning scenarios based on a respective net present value and a respective tax credit to generate a ranked list of the plurality of planning scenarios, and generating a visualization comprising the ranked list of the planning scenarios.

### CROSS-REFERENCE TO RELATED APPLICATION

This application claims priority to and the benefit of U.S. Provisional Application No. 63/511,467, filed on Jun. 30, 2023, and entitled, “MINIMIZING EMISSIONS IN OIL AND GAS FILED DEVELOPMENT PLANNING,” which is incorporated herein by reference in its entirety for all purposes.

### INTRODUCTION

This disclosure relates generally to providing plans, workflows, and recommendations for improving sustainability parameters across oil and gas operations.

### BACKGROUND

As hydrocarbons are extracted from hydrocarbon reservoirs via hydrocarbon wells in oil and/or gas fields, the extracted hydrocarbons may be transported to various types of equipment, tanks, processing facilities, and the like via transport vehicles, a network of pipelines, and the like. For example, the hydrocarbons may be extracted from the reservoirs via the hydrocarbon wells and may then be transported, via the network of pipelines, from the wells to various processing stations that may perform various phases of hydrocarbon processing to make the produced hydrocarbons available for use or transport.

The transported hydrocarbons may be processed or refined into suitable hydrocarbon products and ultimately distributed to end consumers. Overall, the hydrocarbon industry may be characterized as encompassing upstream, midstream, and downstream stages. At each of these stages, sustainability parameters such as energy, carbon, waste, water, and the like may be consumed or used. As oil and gas companies move towards becoming more sustainable organizations, it may be challenging to improve sustainability parameters while simultaneously improving financial or economic parameters associated with the oil and gas production.

Oil and gas play a significant role in the transition from a fossil fuel dominated energy scene to a clean and sustainable one. Still, oil and gas companies may want to minimize their environmental impact from oil and gas production to work towards a zero-carbon strategy and receive tax credit benefits for reduced emissions. Automated planning techniques for identifying suitable locations and placements for components used for hydrocarbon extraction, processing, and distribution operations may involve a significant amount of processing power and hardware to efficiently determine suitable locations for various components in view of both financial considerations and sustainability considerations. That is, systems for determining suitable locations for components of a hydrocarbon operation that improve sustainability and profitability alike may take days to process the relevant information and identify the most viable solutions. Moreover, these systems may identify suitable locations for a limited number of components (e.g., 10-20 wells, drill centers, gathering centers, and/or central processing centers) that make up the hydrocarbon operation. The delay and limited number of components analyzed in determining the suitable locations may result in delayed operations, higher costs, higher emissions, and reduced efficiencies in processes related to hydrocarbon extraction and processing.

This section is intended to introduce the reader to various aspects of art that may be related to various aspects of the present techniques, which are described and/or claimed below. This discussion is believed to be helpful in providing the reader with background information to facilitate a better understanding of the various aspects of this disclosure. Accordingly, it should be understood that these statements are to be read in this light, and not as admissions of prior art.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In some embodiments, a method for determining emissions costs for a hydrocarbon production site may include receiving input data comprising geological data associated with an area, an indication of a set of components to be placed in a layout for the hydrocarbon production site, and an emission cost estimate for each of the set of components, where the set of components may include one or more wells, two or more facilities, one or more pipelines disposed between the two or more facilities, and one or more well trajectories associated with the one or more wells and at least one of the two or more facilities. The method may also include defining one or more uncertainty parameters for the emission cost estimate for each for the set of components. The method may also include generating a plurality of planning scenarios to implement for the layout based on the set of components and the one or more uncertainty parameters for the emission cost estimate for each for the set of components. Additionally, the method may include simultaneously determining a set of facility placements for the two or more facilities, a set of well trajectories associated with the one or more wells, a set of pipeline placements for the one or more pipelines, and a set of net present values for each of the plurality of planning scenarios. The net present value may be indicative of an expected economic performance of each of the plurality of planning scenarios. Further, the method may include calculating a tax credit for each of the plurality of planning scenarios. The method may also include ranking each of the plurality of planning scenarios based on a respective net present value and a respective tax credit to generate a ranked list of the plurality of planning scenarios. Additionally, the method may include generating a visualization for display via an electronic display, wherein the visualization comprises the ranked list of the plurality of planning scenarios.

Various refinements of the features noted above may be made in relation to various aspects of this disclosure. Further features may also be incorporated in these various aspects as well. These refinements and additional features may be made individually or in any combination. For instance, various features discussed below in relation to one or more of the illustrated embodiments may be incorporated into any of the above-described aspects of this disclosure alone or in any combination. The brief summary presented above is intended only to familiarize the reader with certain aspects and contexts of embodiments of this disclosure without limitation to the claimed subject matter.

For clarity and simplicity of description, not all combinations of elements provided in the embodiments recited above have been set forth expressly. Notwithstanding this, the skilled person will directly and unambiguously recognize that unless it is not technically possible, or it is explicitly stated to the contrary, the consistory clauses referring to one aspect of the embodiments described herein are intended to apply mutatis mutandis as optional features of every other aspect of the embodiments presented above to which those consistory clauses could possibly relate.

### BRIEF DESCRIPTION OF THE DRAWINGS

Various features, aspects, and advantages of this disclosure will become better understood when the following detailed description is read with reference to the accompanying figures in which like characters represent like parts throughout the figures, wherein:

FIG. 1 illustrates a schematic diagram of an example hydrocarbon site that may produce and process hydrocarbons, according to one or more embodiments of this disclosure;

FIG. 2 illustrates a block diagram of various components that may be part of a planning system for determining locations of components that may be part of the hydrocarbon site of FIG. 1, according to one or more embodiments of this disclosure;

FIG. 3 is a block diagram of logical layers for components that may be part of the hydrocarbon site of FIG. 1, according to one or more embodiments of this disclosure;

FIG. 4 is a block diagram of an example analysis that a hydrocarbon planning system may utilize when estimating emissions for possible layouts for a hydrocarbon site, according to one or more embodiments of this disclosure;

FIG. 5 is a flow chart of a method for simultaneous optimization for facility operations employing the sustainability platform system of FIG. 3, according to one or more embodiments of this disclosure;

FIG. 6 is a flow chart of an overview of uncertainty management and emission minimization workflow, according to one or more embodiments of this disclosure;

FIG. 7 is a flow chart of the uncertainty management and emission minimization workflow described in FIG. 6, according to one or more embodiments of this disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The drawing figures are not necessarily to scale. Certain features of the embodiments may be shown exaggerated in scale or in somewhat schematic form, and some details of conventional elements may not be shown in the interest of clarity and conciseness. Although one or more embodiments may be preferred, the embodiments disclosed should not be interpreted, or otherwise used, as limiting the scope of the disclosure, including the claims. It is to be fully recognized that the different teachings of the embodiments discussed may be employed separately or in any suitable combination to produce desired results. In addition, one skilled in the art will understand that the description has broad application, and the discussion of any embodiment is meant only to be exemplary of that embodiment, and not intended to intimate that the scope of the disclosure, including the claims, is limited to that embodiment.

When introducing elements of various embodiments of this disclosure, the articles “a,” “an,” and “the” are intended to mean that there are one or more of the elements. The terms “including” and “having” are used in an open-ended fashion, and thus should be interpreted to mean “including, but not limited to . . . ” Any use of any form of the terms “couple,” or any other term describing an interaction between elements is intended to mean either an indirect or a direct interaction between the elements described.

Certain terms are used throughout the description and claims to refer to particular features or components. As one skilled in the art will appreciate, different persons may refer to the same feature or component by different names. This document does not intend to distinguish between components or features that differ in name but not function, unless specifically stated.

Hydrocarbon sites may include a number of components that facilitates the extraction, processing, and distribution of hydrocarbons (e.g., oil) from a well or well site. When initially analyzing a potential hydrocarbon extraction site, a number of factors are considered to identify the types of facilities to place at the hydrocarbon site, the locations of the facilities, the distance between facilities, the locations of the reservoir well sections (e.g., wells themselves), well trajectories, the placement of pipelines disposed between such facilities, and the like. For example, the locations of the wells themselves, well trajectories, the placement of facilities, and/or the placement of pipelines disposed between such facilities may be analyzed for viability, time or cost efficiency, reservoir production, or any combination thereof.

At each stage of operations, a certain amount of greenhouse gas emissions may be produced when performing various tasks associated with each stage. As industries move to providing a net zero carbon enterprise, the greenhouse gas emissions produced during these stages should be removed from the atmosphere. A number of action plans may be related to removing carbon from the atmosphere including afforestation, reforestation, soul carbon sequestration, carbon capture and storage technology, direct air capture technology, ocean fertilization, reducing emissions at the source, switching to sustainable power sources, reusing previously discarded resources, and the like. In addition to net zero carbon operations, industries are working to achieve improved sustainability parameters that reduce waste, conserve resources, and reduce the effects that their respective operations have on the environment.

Identifying an oil or gas facility development plan that maximizes economic value while minimizing environmental damage is a major challenge in the industry. Current methods for balancing economic and environmental criteria of oil and gas facilities focus primarily on the uncertainty about the geological characteristics and properties of the subsurface reservoirs where hydrocarbons are located. Further, existing solutions do not consider the impact of uncertainty on field development planning elements to select an optimal field development planning scenario, nor combine uncertainty and emissions estimates to select a field development planning scenario that maximizes economic value and minimizes emissions. The present disclosure, however, focuses on the uncertainty of certain variables involved in the development of an oil or gas facility, the production of oil and gas, and the associated uncertainty of the costs of those variables, in an integrated way in order to select the facility development plan that strikes a balance between economic values and environmental responsibilities.

To address this challenge, the present disclosure describes an approach to systematically and comprehensively screen potential options for developing an economically competitive gas or oil facility with the least environmental impact using available knowledge of emissions costs. Specifically, the approach explores multiple variables that may be adjusted or chosen to determine the profitability or environmental impact of an oil or gas facility. Further, the approach considers the lack of precise knowledge or predictability (i.e., uncertainty) regarding such variables. This multidimensional space of decision variables, together with the uncertainty of the variables, may be used to generate multiple potential and technically viable development scenarios. After a development scenario is identified and selected, the emission costs and a tax-credit modified net present value may be calculated for the scenario, resulting in an optimal scenario balanced between economic and environmental criteria.

For example, the approach may involve screening for the most viable or profitable development concepts. The most viable concepts from a financial perspective may then be ranked based on their emissions while also accounting for the potential corresponding tax credit. Before the optimal development scenario can be identified, the approach may involve considering several uncertainty variables associated with decisions that may be made to maximize the value of an oil or gas facility. Examples of such variables may include the number of wells, the well type (e.g. vertical, deviated or horizontal wells), the location of these wells in the reservoir layers, the enhanced oil recovery scheme, the ratio of injection to production wells, the drill center locations, the gathering center locations, the number and capacity of each of these, and other factors or considerations that may be chosen or adjusted when planning the development of an oil or gas facility.

Each decision variable may be identified a priori together with its range of variability. Furthermore, an estimated cost associated with the uncertainty of each of the decision variables may be considered. The optimal solution incorporating both the financial and environmental considerations may then be identified based, at least in part, on the relative cost of each of these decision variables and accounting for topological complexities and prohibited areas. It should be noted that the multiple decision variables, together with the inherent uncertainty of the costs associated with these decisions, may render the identified optimal solution to be an unrealistic plan. As such, the present approach may involve a method that identifies multiple potential solutions through sampling the multidimensional space of parameters based on the ranges of variability of the decision variables and the ranges of uncertainty of the associated costs.

Indeed, the method may include a Latin-hypercube method for a prescribed number of samples, N_{S}. For example, in one embodiment, a well and facility placement engine may be used for each of the samples resulting in a total of N_{S} solutions of the problem encompassing the variability of the decision variables and the uncertainty of associated costs. Each of the solutions may have an associated net present value (NPV) resulting in a distribution of NPV. The NPV of each solution may then be used to sort the solutions and identify the top performing solutions based on a prescribed range of closeness in economic performance. That is, within this range of economic performance, a portion of the plurality of planning scenarios (e.g. the selected “best” scenarios) are identified and may be considered “similar” from an economic performance point of view; a total number of N_{sb}. In this way, the best ranked planning scenarios (i.e. the portion of the plurality of planning scenarios) have a net present value above a first threshold and a tax credit above a second threshold. A ranked list may then be generated based on the ranked planning scenarios.

After a development scenario or solution is identified and selected, the emission costs and a tax-credit modified net present value may be calculated for the scenario, resulting in an optimal scenario balanced between economic and environmental criteria. Emission costs are allocated to each element in the production system. Accordingly, each of the N_{sb} scenarios resulting from the above-described method may have an associated “emission cost” calculated by summing up the emission cost of each of its elements. Examples of emissions costs may include factors such as well drilling and completion, facility node in any layer of the production system, unit of pipeline length in any layer of the production system, cost of producing per barrel of oil/cubic feet of gas, processing barrels of produced water, or processing barrels of injected water, or other similar emissions considerations. The tax credit may correspond to the environmental sustainability properties associated with each of the plurality of planning scenarios. For example, the scenario with the highest emissions may be assigned a zero “tax credit”. Then, a tax credit (USD) may be calculated for each of the remaining scenarios based on incremental emission quantity compared to the “reference scenario.” A new tax-credit modified NPV (NPV tax credit) may then be calculated for each of the scenarios by adding the NPV to the tax credit of each of the scenarios. Scenarios are then ranked based on their tax-credit modified NPV and highest ranked scenarios are considered for a second, more detailed round of assessment. A ranked listed may be generated based on the ranked planning scenarios.

By incorporating the systems and techniques described herein, it is possible to address the disconnect between maximizing the economic value of an oil and gas facility while also minimizing emissions and, hence, working towards limiting global warming.

It should be noted that although the following description of various embodiments for improving sustainability parameters is described with respect to hydrocarbon facility operations, it should be understood that the embodiments described herein may be applied to any suitable industry including utilities, cementing operations, steel factories, and the like. Further, although the following description of the various methodologies may be detailed in the context of a particular industry or technology area, it should be noted that the methodologies described herein may be implemented within other suitable areas.

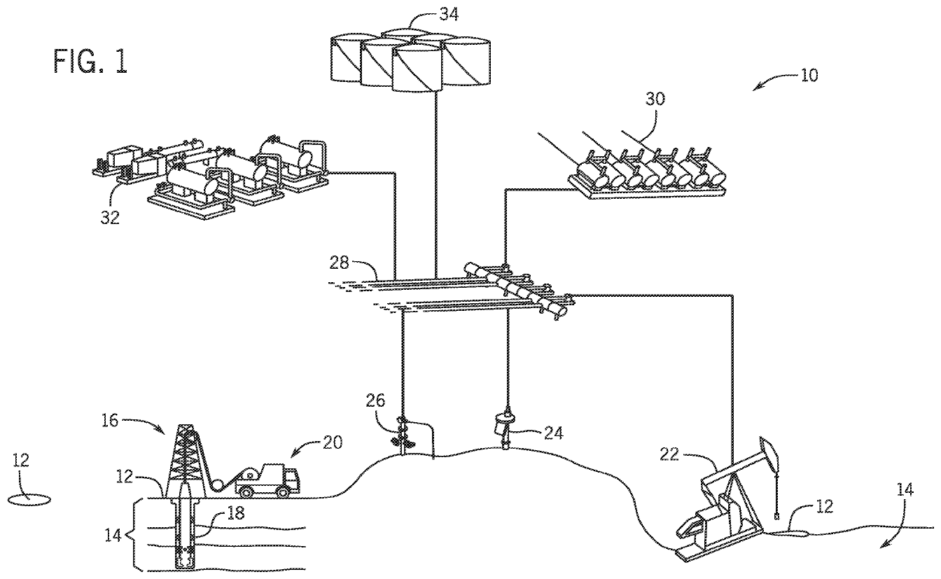

By way of introduction, FIG. 1 the hydrocarbon site 10 may include a number of wells 12 disposed within a geological formation 14. The wells 12 may include drilling platform 16 that may have performed a drilling operation to drill out a wellbore 18. Additionally, as used herein, wells 12 may generally refer to physical components such as the drilling platform 16 and wellbore 18 and/or the general area of the reservoir in which extraction is desired (e.g., a reservoir well section). The drilling operations may include drilling the wellbore 18, injecting drilling fluids into the wellbore 18, performing casing operations within the wellbore 18, and the like. In addition to including the drilling platform 16, the hydrocarbon site 10 may include surface equipment 20 that may carry out certain operations, such as cement installation operation, well logging operations to detect conditions of the wellbore 18, and the like. As such, the surface equipment 20 may include equipment that store cement slurries, drilling fluids, displacement fluids, spacer fluids, chemical wash fluids, and the like. The surface equipment 20 may include piping and other materials used to transport the various fluids described above into the wellbore 18. The surface equipment 20 may also include pumps and other equipment (e.g., batch mixers, centrifugal pumps, liquid additive metering systems, tanks, etc.) that may fill in the interior of a casing string with the fluids discussed above.

In addition to the equipment used for drilling operations, the hydrocarbon site may include a number of well devices that may control the flow of hydrocarbons being extracted from the wells 12. For instance, the well devices in the hydrocarbon site 10 may include pumpjacks 22, submersible pumps 24, well trees 26, and the like. The pumpjacks 22 may mechanically lift hydrocarbons (e.g., oil) out of the well 12 when a bottom hole pressure of the well 12 is not sufficient to extract the hydrocarbons to the surface. The submersible pump 24 may be an assembly that may be submerged in a hydrocarbon liquid that may be pumped. As such, the submersible pump 24 may include a hermetically sealed motor, such that liquids may not penetrate the seal into the motor. Further, the hermetically sealed motor may push hydrocarbons from underground areas or the reservoir to the surface. The well trees 26 may be an assembly of valves, spools, and fittings used for natural flowing wells. As such, the well trees 26 may be used for an oil well, gas well, water injection well, water disposal well, gas injection well, condensate well, and the like. By way of reference, the wells 12 may be part of a first hierarchical level and the well devices that extract hydrocarbons from the wells 12 may be part of a second hierarchical level above the first hierarchical level. Each hierarchical level may include a number of components and the presently disclosed techniques may account for these levels when determining the design plans for the hydrocarbon site 10.

After the hydrocarbons are extracted from the surface via the well devices, the extracted hydrocarbons may be distributed to other devices via a network of pipelines 28. That is, the well devices of the hydrocarbon site 10 may be connected together via a network of pipelines 28. In addition to the well devices described above, the network of pipelines 28 may be connected to other collecting or gathering components, such as wellhead distribution manifolds 30, separators 32, storage tanks 34, and the like.

In some embodiments, the pumpjacks 22, the submersible pumps 24, well trees 26, wellhead distribution manifolds 30, separators 32, and storage tanks 34 may be connected together via the network of pipelines 28. The wellhead distribution manifolds 30 may collect the hydrocarbons that may have been extracted by the pumpjacks 22, the submersible pumps 24, and the well trees 26, such that the collected hydrocarbons may be routed to various hydrocarbon processing or storage areas in the hydrocarbon site 10. The separator 32 may include a pressure vessel that may separate well fluids produced from oil and gas wells into separate gas and liquid components. For example, the separator 32 may separate hydrocarbons extracted by the pumpjacks 22, the submersible pumps 24, or the well trees 26 into oil components, gas components, and water components. After the hydrocarbons have been separated, each separated component may be stored in a particular storage tank 34. The hydrocarbons stored in the storage tanks 34 may be transported via the pipelines 28 to transport vehicles, refineries, and the like.

Although the hydrocarbon site 10 is described above with certain components, it should be understood that the hydrocarbon site 10 may include additional, fewer, or different components. For example, although discussed above in relation to a hydrocarbon site 10 on land, present embodiments may also include analysis of off-shore hydrocarbon sites 10 and the components thereof. That is, the embodiments described herein are directed to determining a design for any suitable hydrocarbon site that may include various types of components that is related to the production and distribution of hydrocarbons. In this way, the components depicted in FIG. 1 are provided as an example context in which the embodiments described herein may be implemented. As such, the embodiments of this disclosure should not be limited to the components listed in FIG. 1. Moreover, additional components relating to on- or off-shore hydrocarbon production may be implemented as additional layers (e.g., hierarchical or functional) in the modular planning system.

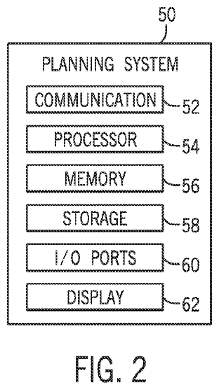

Keeping this in mind, the present embodiments described herein may include systems and methods for identifying components (e.g., well devices) and locations for components in the hydrocarbon site 10 based on design data related to the hydrocarbon site. By way of operation, a planning system 50, as presented in FIG. 2, may receive the input data and identify a set of locations for the components in the hydrocarbon site 10.

Referring now to FIG. 2, the planning system 50 may include any suitable computing device, cloud-computing device, or the like and may include various components to perform various analysis operations. As shown in FIG. 2, the planning system 50 may include a communication component 52, a processor 54, a memory 56, a storage component 58, input/output (I/O) ports 60, a display 62, and the like. The communication component 52 may be a wireless or wired communication component that may facilitate communication between different monitoring systems, gateway communication devices, various control systems, and the like. The processor 54 may be any type of computer processor or microprocessor capable of executing computer-executable code. The memory 56 and the storage component 58 may be any suitable articles of manufacture that can serve as media to store processor-executable code, data, or the like. These articles of manufacture may represent non-transitory computer-readable media (i.e., any suitable form of memory or storage) that may store the processor-executable code used by the processor 54 to perform the presently disclosed techniques. The memory 56 and the storage component 58 may also be used to store data received via the I/O ports 60, data analyzed by the processor 54, or the like.

The I/O ports 60 may be interfaces that may couple to various types of I/O modules such as sensors, programmable logic controllers (PLC), and other types of equipment. For example, the I/O ports 60 may serve as an interface to pressure sensors, flow sensors, temperature sensors, and the like. As such, the planning system 50 may receive data associated with a well via the I/O ports 60. The I/O ports 60 may also serve as an interface to enable the planning system 50 to connect and communicate with surface instrumentation, servers, and the like.

The display 62 may include any type of electronic display such as a liquid crystal display, a light-emitting-diode display, and the like. As such, data acquired via the I/O ports and/or data analyzed by the processor 54 may be presented on the display 62, such that the planning system 50 may present designs for hydrocarbon sites 10 for view. In certain embodiments, the display 62 may be a touch screen display or any other type of display capable of receiving inputs from an operator. Although the planning system 50 is described as including the components presented in FIG. 2, the planning system 50 should not be limited to including the components listed in FIG. 2. Indeed, the planning system 50 may include additional or fewer components than described above.

It should also be noted that for the sake of modularity and flexibility with regard to both the size and specifications of the targeted facility optimization problem, the planning system 50 may be implemented over a web application with back-end and front-end components. In this scheme, the back-end component may be responsible for handling certain optimization algorithms, while the front-end component may be used to set optimization problem specifications and parameters from a user's perspective as detailed further below. The communication between the front-end component and back-end component of the planning system 50 may involve communications over any suitable network.

In some embodiments, the planning system 50 may apply an optimization scheme such as the Particle Swarm Optimization (PSO) algorithm to input data in a way to tolerate various features in order to solve practical onshore and offshore hydrocarbon facilities' scenarios. That is, the planning system 50 may use the PSO algorithm to solve an optimization problem related to designing the hydrocarbon site 10. By way of example, the optimization problem may correspond to constructing the hydrocarbon site 10 at a threshold cost to produce a threshold amount of hydrocarbons over some period of time. To define the optimization problem or optimization parameters for the optimization problem, the planning system 50 may evaluate the hydrocarbon site 10 according to certain hierarchical or logical layers.

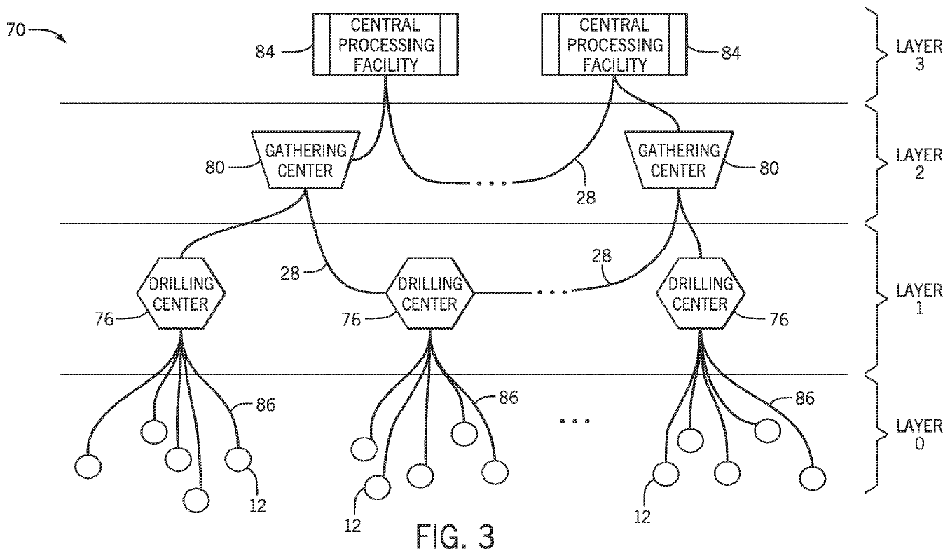

For example, FIG. 3 is a block diagram of logical layers 70 for components that may be part of the hydrocarbon site 10. The logical layers 70 may detail different logical groupings of various components that may be part of the hydrocarbon site 10. As such, each layer of the logical layers 70 may include a collection of nodes that perform some similar function. By way of example, referring to FIG. 3, the wells 12 may be nodes that are part of a layer 0. The wells 12 may correspond to locations in which hydrocarbons may be produced. Layer 1 may include drilling centers 76, which may correspond to the drilling platform 16, various types of well devices (e.g., pumpjacks 22, submersible pumps 24, well trees 26) used for extracting the hydrocarbons from the wells 12 in the layer 0. In the same manner, layer 2 may receive output from the drilling centers 76 at gathering centers 80 (e.g., wellhead distribution manifolds 30, separators 32). Layer 3 may be hierarchically positioned above layer 2 and may include central processing facilities 84 (e.g., storage tanks 34) that may collect the outputs of the gathering centers 80. The central processing facilities 84 may, in some embodiments, be positioned within a threshold distance of distribution channels (e.g., transcontinental pipeline, shipyard, highway) to enable the processed hydrocarbons to be transported to a destination site.

As illustrated in FIG. 3, a four-layer facility of the hydrocarbon site 10 with layers 0 to 3 correspond to wells, drilling centers, gathering centers, and central processing field, respectively. In this way, the logical layers 70 provide an example case of a production system optimization problem that includes Nₗ (l=1, . . . , Nₗ) logical layers (e.g., 0, 1, 2, 3), such that each layer contains

$${N}_{n}^{l} ( n = 1 , … , {N}_{n}^{l} )$$

nodes. Layer 0 denotes the wells 12 with

$${N}_{n}^{0} = {N}_{w} .$$

Layer 0 is (e.g., horizontal well sections) input to the facility placement optimization problem. Therefore, the planning system 50 may solve an optimization problem presented below starting from layer 1 and above. As should be appreciated, the number of layers may be increased or decreased to add or remove complexity. Furthermore, the planning system 50 may optimize connections between the layers 70, such as pipelines 28 and/or well trajectories 86 simultaneously or separately.

Referring to FIG. 3, the planning system 50 may perform a modular optimization of the number and location of nodes in each logical layer to minimize an overall cost in building the collection of nodes in the hydrocarbon site 10. That is, the production facilities identified by the planning system 50 may be related to a multi-layer tree, in which each layer in this tree denotes one logical layer. As such, the planning system 50 solves an optimization problem that minimizes a total cost for building the facilities or other components that correspond to the nodes based on the logical layers with wells (layer 0), drilling centers (layer 1), gathering centers (layer 2), and central processing facility (layer 3), and the nodes of each logical layer (layer l) that are connected to nodes in an upper layer (layer l+1) through pipelines 28 (e.g., connections). Moreover, the planning system 50 may combine the determined facility placements with the A* searching algorithm to optimize pipeline layouts that connect nodes to another node or other nodes.

Keeping this in mind, optimization parameters that may be used by the planning system 50 to solve the optimization problem may include the following:
(1) Number of nodes,

$${N}_{n}^{l} ,$$

in layer (, l=1, . . . , Nₗ;
(2) Nodes coordinates

$${X}_{i}^{l} , {Y}_{i}^{l} , and {Z}_{i}^{l} , i = 1 , … , {N}_{n}^{l} ;$$

(3) Number of nodes in layer l−1 connected to each node in layer l;
(4)

$${C}_{ij}^{l} :$$

the assignment of node j in layer l−1 to its corresponding node i in layer l,

$$where {C}_{ij}^{l} = \{ \begin{matrix}0 , if node j in layer l - 1 is not connected to node i in layer l \\ 1 , if node j in layer l - 1 is connected to node i in layer l\end{matrix}$$

(5) Pipeline placement; the optimal path connecting two nodes on a given physical layer. Example: pipelines connecting drilling centers to gathering centers. This can be, optionally, simplified so that these pipelines can be replaced by the Euclidean distance between the two nodes. Moreover, the optimal path may be formed of multiple nodes between a starting point and a target point, and optimization may utilize the location of each node on the path.
(6) Well trajectory; the optimal trajectory for a wellbore 18 from the surface to the well location. Further, optimization of well trajectories may include changing control points and/or kick-off points (KOPs).

Based on the logical layers 70 of the hydrocarbon site 10, the planning system 50 may focus on minimizing a well-defined objective function for facility optimization: TC, which represents a facility total cost (USD) combining the various nodes costs as well as the corresponding connections costs. An example optimization problem that may be defined for the planning system 50 is provided below in Equation (1).

$$T C = {\sum }_{l = 1}^{{N}_{l}} [ ( {C}_{n}^{l} \times {N}_{a}^{l} ) + ( {C}_{c}^{l} \times T {D}_{a}^{l} ) \qquad ( 1 )$$

Referring to Equation (1),

$${C}_{n}^{l} and {C}_{c}^{l}$$

are the cost of the node in USD and the cost of the connection in USD per meter for layer l, respectively.

$${N}_{a}^{l} and {TD}_{a}^{l}$$

are the actual number of nodes placed in layer l, where

$${N}_{a}^{l}$$

is less than or equal to the maximum number of nodes that can be used in the layer, and the total distance in meters from nodes in layer l−1 to nodes in layer l, respectively.

As may be appreciated, a tradeoff may exist between the facility placement costs (e.g., chosen nodes costs) and the drilling and facility costs (e.g., pipelines connecting the various hierarchical layers of the hydrocarbon site 10), where the goal is to reach an optimal solution that minimizes a total facility cost. In addition to the optimization problem detailed above, the planning system 50 may be limited to identifying solutions based on certain constraints. For example, a list of a set of constraints of the above optimization problem, for each layer l, l=1, . . . , Nₗ may include the following:
(1) Maximum number of nodes in layer l, l=1, . . . , Nₗ:

$${N}_{max}^{l}$$

(2) Capacity of a node in layer l, l=1, . . . , Nₗ:

$${N}_{c}^{l} .$$

This is the maximum number of nodes in layer l−1 that can connect to a node in layer l
(3) The minimum number of nodes

$${N}_{min}^{l}$$

acceptable in layer l is calculated based on the nodes' capacity in layer l and actual number of nodes in layer l−1:

$${N}_{min}^{l} = {N}_{a}^{l - 1} / {N}_{c}^{l}$$

Before describing details regarding implementing the optimization algorithm to identify locations for components in the hydrocarbon site 10, it should be noted that the planning system 50 may or may not analyze certain components of the hydrocarbon site simultaneously. In general, after a hydrocarbon site 10 location is identified through subsurface studies, the design of the production system becomes an optimization problem with respect to time and costs. Aspects of the production system change from onshore to offshore fields and include for an offshore field. For instance, the decision about the number of platforms, placement and sizing the platforms, and wells-platform assignment are variables that may be evaluated in the optimization problem. Throughout the field development planning exercise, including the early phase during which the development concept is selected, various development models may be taken into consideration and may involve careful evaluation for their sustainability, economic viability, and technical feasibility. Over this screening stage, the planning system 50 may implement an iterative workflow where various scenarios of facility development optimization are evaluated. As a result, the planning system 50 may implement a highly efficient facility placement optimization scheme that is both profitable and environmentally friendly as described below. Furthermore, the efficiency of the optimization scheme may be variable.

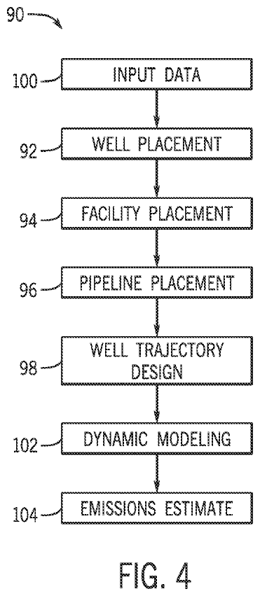

To help illustrate, FIG. 4 is a block diagram of an example scenario 90 that the planning system 50 may utilize when formulating optimal layouts for a sustainable hydrocarbon site (e.g., hydrocarbon site 10). The approach described herein may systematically and comprehensively screen the technical potential options to develop a gas or oil facility. Oil and gas facility development planning typically aims ultimately at maximizing hydrocarbon recovery while minimizing capital investment and hence maximizing some financial driving values (e.g. NPV). In the case of onshore oil and gas facility development, for instance, facility development planning may include the number, capacity, and location of drill centers and gathering centers as wells as pipeline layout. Further, facility development planning may involve optimally placing a certain number of production and injection wells in the reservoir as well as optimizing the pipeline and facility layout and well trajectories.

For example, in the example scenario of FIG. 4, each set of well placements 92, facility placements 94, pipeline placements 96, and well trajectory designs 98 are determined separately based on input data 100 and a previously performed analysis. In other words, the optimization of each component is independently determined based on the input data 100 and any other analysis performed prior to the respective optimization analysis. Indeed, while the location or selection of certain components may be related to that of other components (e.g., pipeline placements are dependent upon facility locations), independent analysis via dynamic modeling 102, as referred to herein, corresponds to performing analysis without simultaneous consideration. Then, emission costs for the scenario are estimated 104 and a tax-credit modified net present value is calculated for each of the high performing scenarios based on which the least emitting scenario is selected resulting in an optimal scenario balancing between economic and environmental criteria. In this way, the approach described herein systematically and comprehensively screens the technical potential options to develop a gas or oil facility and uses the available knowledge of emissions costs to select the most environmentally friendly, yet economically competitive development scenario.

In some embodiments, the planning system 50 may select a scenario to achieve an optimal solution of components within a specified (e.g., user specified) computational resource parameter (e.g. lower emissions). Furthermore, one or more user preferences or selections may set a priority (e.g., on a continuous or discrete scale) between a computation efficiency and an accuracy of optimization. In addition, the planning system 50 may receive a user selection for a maximum cost value for a particular hydrocarbon site 10 and the planning system 50 may select an appropriate scenario based on the maximum cost value. That is, to find lower cost solutions, the planning system 50 may select a scenario that has higher computational complexities. As discussed above, independent analyses may use any suitable placement algorithm.

Furthermore, while present techniques utilize an optimization algorithm such as PSO to select and/or place the components of the hydrocarbon site 10, independently analyzed components may use a separate (e.g., independent) PSO algorithm or other analysis techniques. For example, other techniques may be used to identify well placement or well trajectory separate from facility placement and/or pipeline placement. For example, a well placement algorithm may use a net hydrocarbon thickness map to place wells using a black hole algorithm. Furthermore, even if well placement and well trajectory are not provided as outputs by the planning system 50, this does not significantly impact the purpose of facility design (e.g., identification and placement of components in the hydrocarbon site 10).

As discussed above, in some embodiments, the planning system 50 may employ a PSO algorithm for identifying locations for components in the hydrocarbon site 10. As should be appreciated, other optimization algorithms may be used in place of the PSO algorithm. Although the following description of the method is described as being performed by the planning system 50, it should be understood that any suitable computing system may perform the method. Additionally, although the method is described in a particular order, it should be noted that the method may be performed in any suitable order.

As mentioned above, the planning system 50 may be implemented over a web application with back-end and front-end components. In this scheme, the back-end component may be responsible of handling certain optimization algorithms, while the front-end component may be used to set optimization problem specifications and parameters from a user's perspective as will be detailed below. The communication between the front-end component and back-end component of the planning system 50 may involve communications over any suitable network.

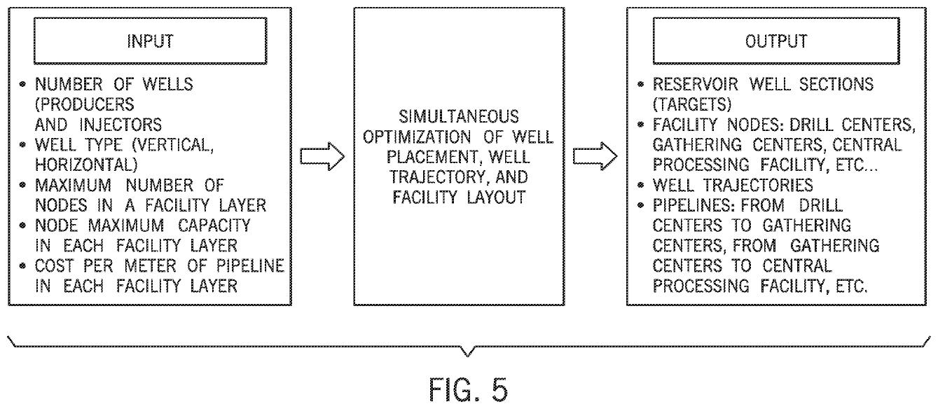

FIG. 5 shows the process for optimization of an oil and gas facility layout. As shown in FIG. 5, the input may include a well count and a well type, which may be prescribed together, a maximum number of nodes in every layer (e.g. drill centers, gathering centers, etc.), and a cost and capacity of these nodes. Similarly, the cost per matter of pipelines in every layer of the solution may be provided as input to this step. When processing the input data, the planning system 50 may perform simultaneous optimization of well placement, well trajectory, and facility layout as described above. As a result, the planning system 50 may generate outputs that may include wells placements in the reservoir, reservoir well sections (e.g., targets), facility nodes, drill centers, gathering centers, central processing facilities, and the like. In addition, the outputs may include pipeline placements between these locations. In some embodiments, facility nodes may be placed and pipelines may be laid out all to minimize capital expenditure or maximize NPV.

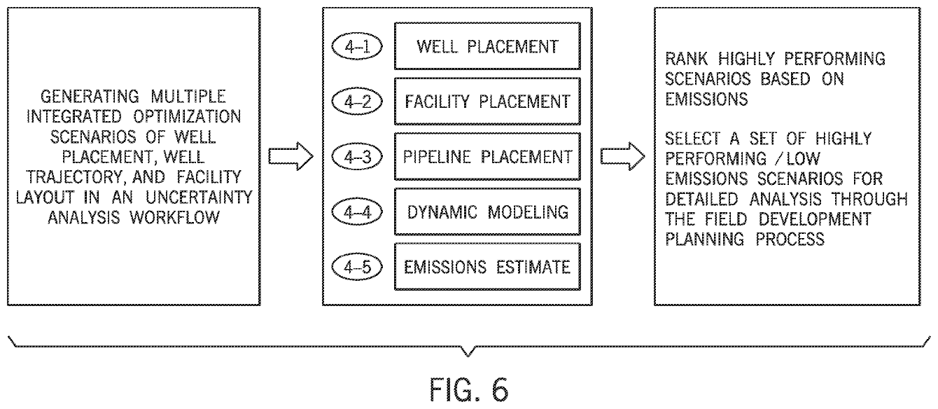

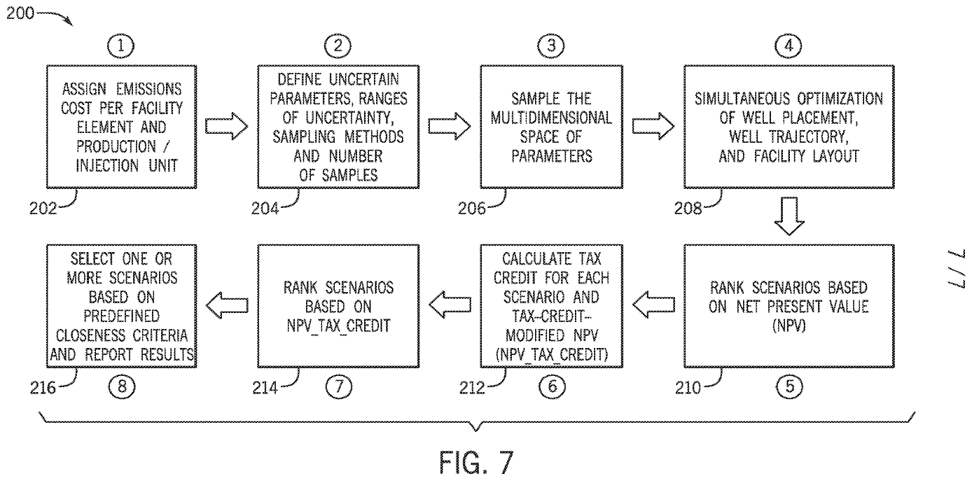

With the foregoing in mind, FIG. 6 is a flowchart demonstrating an overview of the workflow adopted in the process of accounting for uncertainty in integrated optimization of well placement, well trajectory and facility layout and, accordingly, selecting the development concept/scenario that minimizes emissions. The different building blocks of the workflow are detailed in the FIG. 7. The method depicted in FIG. 6 generally addresses the disconnect between maximizing the economic value of an oil and gas facility while actively contributing to minimizing emissions and, hence, helping towards limiting global warming. Unlike the conventional processes where the focus is on subsurface uncertainty, the approach described herein addresses the impact of uncertainty on the different elements involved in facility development and production and the associated uncertainty of the costs of the elements in an integrated way to select the facility development plan that strikes a balance between economic values and environmental responsibilities. For example, this may be achieved by screening for the most viable or profitable development concepts or facility layout.

The approach may also involve considering several uncertainty variables associated with decisions that may be made to maximize the value of an oil or gas facility. Examples of such variables may include the number of wells, the well type (e.g. vertical, deviated or horizontal wells), the location of these wells in the reservoir layers, the enhanced oil recovery scheme, the ratio of injection to production wells, the drill center locations, the gathering center locations, the number and capacity of each of these, and other factors or considerations that may be chosen or adjusted when planning the development of an oil or gas facility.

Each decision variable may be identified a priori together with its range of variability. Furthermore, an estimated cost associated with the uncertainty of each of the decision variables may be considered. The optimal solution incorporating both the financial and environmental considerations is then identified based, at least in part, on the relative cost of each of these decision variables and accounting for topological complexities and prohibited areas. It is important to note that the multiple decision variables, together with the inherent uncertainty of the costs associated with these decisions, may render the identified optimal solution to be an unrealistic plan. As such, the present approach may involve a method that identifies multiple potential solutions, as discussed above, through sampling the multidimensional space of parameters based on the ranges of variability of the decision variables and the ranges of uncertainty of the associated costs.

Indeed, as mentioned above, the method may include a Latin-hypercube method for a prescribed number of samples, N_{S}. For example, in one embodiment, a well and facility placement engine may be used for each of the samples resulting in a total of N_{S} solutions of the problem encompassing the variability of the decision variables and the uncertainty of associated costs. Each of the solutions may have an associated net present value (NPV) resulting in a distribution of NPV. The NPV of each solution may then be used to sort the solutions and identify the top performing solutions based on a prescribed range of closeness in economic performance. That is, within this range of economic performance, a portion of the plurality of planning scenarios (e.g. the selected “best” scenarios) are identified and may be considered “similar” from an economic performance point of view; a total number of N_{sb}. The most viable concepts from a financial perspective are then ranked based on their emissions while also accounting for the potential corresponding tax credit. In this way, the best ranked planning scenarios (i.e. the portion of the plurality of planning scenarios) have a net present value above a first threshold and a tax credit above a second threshold. A ranked list may then be generated based on the ranked planning scenarios.

FIG. 7 is a flowchart detailing the method 200 adopted in the approach, according to some embodiments. As shown in FIG. 7, the planning system 50 may allocate emission costs per facility element and production or injection unit (step 202). For instance, emission costs may be determined and allocated with respect to well drilling and completion, a facility node in any layer of the production system, per unit of pipeline length in any layer of the production system, for producing per barrel of oil/cubic feet of gas, for processing one barrel of produced water, for processing of one barrel of injected water, and the like. Accordingly, each of the N_{sb} scenarios resulting from the above section is associated with an “emission cost” calculated by summing up the emission cost of each of its elements. Next, the planning system 50 may define uncertain parameter ranges of uncertainty, sampling methods, and number of samples (step 204) for the calculated emission costs. The planning system 50 may then sample the multidimensional space of the uncertainty parameters (step 206). Uncertainty parameters, as used herein, may be divided between uncertain decision parameters (e.g. well count, well type, etc.) and other uncertain parameters (e.g. costs). Such parameters may be determined by a project team by screening possibilities or scenarios and identifying those parameters. For example, if there is only one scenario and no uncertainty or possibilities, there may not be any room for optimization. Because of the uncertainty, and hence possibility of different scenarios or options, one may identify the scenario or option that maximizes the NPV while minimizing emissions. On the other hand, it should be noted that the multiple decision variables, together with the inherent uncertainty of the costs associated with these decisions, may render the identified optimal solution to be an unrealistic plan. As such, the present approach may involve a method that identifies multiple potential solutions through sampling the multidimensional space of parameters related to the emission costs based on the ranges of variability of the decision variables and the ranges of uncertainty of the associated costs. The planning system 50 may perform a simultaneous optimization of well placement, well trajectory, and facility layout (step 208) with respect to the uncertainty ranges of the emissions costs. As described above, the optimization process may generate multiple development scenarios through sampling a multidimensional space of uncertain decision parameters. The planning system 50 may then rank the most viable scenarios from a financial point of view based on their emission costs and/or NPV (step 210). Additionally, the planning system 50 may calculate a tax credit for each scenario and a tax-credit-modified NPV (step 212). For example, the scenario with the highest emissions may be assigned a zero “tax credit”. A tax credit (USD) may be calculated for each of the remaining scenarios based on incremental emission quantity compared to the “reference scenario.” A new tax-credit modified NPV (NPV tax credit) may then be calculated for each of the scenarios by adding the NPV to the tax credit of each of the scenarios. Then, the planning system 50 may rank the scenarios based on the calculated NPV tax credit (step 214). As such, a development scenario may be selected that meets both the financial and environmental requirements. This may result in an optimal scenario or solution that is balanced between economic and environmental criteria.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112 (f). However, for any claims containing elements designated in any other manner, it is intended that such elements are not to be interpreted under 35 U.S.C. 112(f).

While only certain features of the present disclosure have been illustrated and described herein, many modifications and changes will occur to those skilled in the art. It is, therefore, to be understood that the appended claims are intended to cover all such modifications and changes as fall within the true spirit of the embodiments described herein.

What is claimed is:

1. A method, comprising:
receiving input data comprising geological data associated with an area, an indication of a set of components to be placed in a layout for the hydrocarbon production site, and an emission cost estimate for each of the set of components, wherein the set of components comprises one or more wells, two or more facilities, one or more pipelines disposed between the two or more facilities, and one or more well trajectories associated with the one or more wells and at least one of the two or more facilities;
defining one or more uncertainty parameters for the emission cost estimate for each component of the set of components;
generating a plurality of planning scenarios to implement for the layout based on the set of components and the one or more uncertainty parameters for the emission cost estimate for each for the set of components;
simultaneously determining a set of facility placements for the two or more facilities, a set of well trajectories for the one or more wells, a set of pipeline placements for the one or more pipelines, and a set of net present values for each of the plurality of planning scenarios;
calculating a tax credit for each of the plurality of planning scenarios;
ranking each of the plurality of planning scenarios based on a respective net present value and a respective tax credit to generate a ranked list of the plurality of planning scenarios; and
generating a visualization for display via an electronic display, wherein the visualization comprises the ranked list of the plurality of planning scenarios.

2. The method of claim 1, wherein ranking each of the plurality of planning scenarios comprises ranking each of the plurality of planning scenarios within a range of economic performance such that a portion of the plurality of planning scenarios is identified.

3. The method of claim 2, wherein the portion of the plurality of planning scenarios has a net present value above a first threshold and a tax credit above a second threshold.

4. The method of claim 1, comprising:
determining the emission cost estimate for each of the set of components;
determining a total emission cost estimate for each of the plurality of planning scenarios based, at least in part, on a sum of the emission cost estimate for each of the set of components; or
both.

5. The method of claim 4, wherein determining the total emission cost estimate comprises determining a first cost of well drilling, a second cost of well completion, a third cost of a facility node in one or more first layers of the production site, a fourth cost of a unit of pipeline length in one or more second layers of the production site, a fifth cost of production per barrel of oil, a sixth cost of production per cubic feet of gas, a seventh cost of processing one or more barrels of produced water, an eighth cost of processing one or more barrels of injected water, or any combination thereof.

6. The method of claim 4, comprising assigning a zero tax credit to a planning scenario of the plurality of planning scenarios that has a highest total emission cost estimate of each of the plurality of planning scenarios.

7. The method of claim 1, wherein the tax credit corresponds to environmental sustainability properties associated with each of the plurality of planning scenarios.

8. The method of claim 1, wherein the net present value is indicative of an expected economic performance of each of the plurality of planning scenarios.

9. A hydrocarbon planning system comprising:
one or more processors; and
a memory storing instructions that, when executed by the one or more processors, are configured to cause the one or more processors to perform operations comprising:
receiving input data comprising geological data associated with an area and a set of components to be placed in a layout for a hydrocarbon production site;
defining one or more uncertainty parameters for each component of the set of components;
determining a cost associated with the one or more uncertainty parameters;
generating a plurality of planning scenarios to implement for the layout based on the set of components and the one or more uncertainty parameters;
determining a total emission cost estimate of each planning scenario of the plurality of planning scenarios;
determining a net present value of each planning scenario of the plurality of planning scenarios based on the cost associated with the one or more uncertainty parameters and the total emission cost estimate;
calculating a tax credit for each of the plurality of planning scenarios;
determining a modified net present value for each planning scenario of the plurality of planning scenarios based on the tax credit;
ranking each of the plurality of planning scenarios based on a respective modified net present value to generate a ranked list of the plurality of planning scenarios; and
generating a visualization for displaying via an electronic display, wherein the visualization comprises the ranked list of the plurality of planning scenarios.

10. The hydrocarbon planning system of claim 9, wherein the set of components comprise one or more wells, two or more facilities, one or more pipelines disposed between the two or more facilities, one or more well trajectories associated with the one or more wells and at least one of the two or more facilities, or any combination thereof.

11. The hydrocarbon planning system of claim 9, wherein the instructions that, when executed by the one or more processors, are configured to cause the one or more processors to perform operations comprising determining a set of facility placements, a set of well trajectories, a set of pipeline placements, and a set of net present values for each of the plurality of planning scenarios.

12. The hydrocarbon planning system of claim 9, wherein the tax credit is associated with environmental sustainability properties of each of the plurality of planning scenarios.

13. The hydrocarbon planning system of claim 9, wherein the net present value and the modified net present value are indicative of economic performance of each of the plurality of planning scenarios.

14. The hydrocarbon planning system of claim 9, wherein ranking each of the plurality of planning scenarios comprises determining a portion of the plurality of planning scenarios, wherein each of the portion of the plurality of planning scenarios is within a range of economic performance.

15. The hydrocarbon planning system of claim 14, wherein each of the portion of the plurality of planning scenarios has a net present value above a first threshold and a tax credit above a second threshold.

16. A computer program comprising computer-executable instructions that, when executed, are configured to cause at least one processor to perform operations comprising:
receiving input data comprising geological data associated with an area, an indication of a set of components to be placed in a layout for a hydrocarbon production site, and an emission cost estimate for each of the set of components, wherein the set of components comprise one or more wells, two or more facilities, one or more pipelines disposed between the two or more facilities, and one or more well trajectories associated with the one or more wells and at least one of the two or more facilities;
defining one or more uncertainty parameters for the emission cost estimate for each component of the set of components;
generating a plurality of planning scenarios to implement for the layout based on the set of components and the one or more uncertainty parameters for the emission cost estimate for each for the set of components;
simultaneously determining a set of facility placements for the two or more facilities, a set of well trajectories for the one or more wells, a set of pipeline placements for the one or more pipelines, and a set of net present values for each of the plurality of planning scenarios;
calculating a tax credit for each of the plurality of planning scenarios;
ranking each of the plurality of planning scenarios based on a respective net present value and a respective tax credit to generate a ranked list of the plurality of planning scenarios; and
generating a visualization for display via an electronic display, wherein the visualization comprises the ranked list of the plurality of planning scenarios.

17. The computer program of claim 16, wherein the computer-executable instructions are configured to cause the at least one processor to perform the operations comprising:
ranking each of the plurality of planning scenarios within a range of economic performance such that a portion of the plurality of planning scenarios is identified.

18. The computer program of claim 17, wherein the portion of the plurality of planning scenarios has a net present value above a first threshold and a tax credit above a second threshold.

19. The computer program of claim 16, wherein the computer-executable instructions are configured to cause the at least one processor to perform the operations comprising:
determining the emission cost estimate for each of the set of components;
determining a total emission cost estimate for each of the plurality of planning scenarios based, at least in part, on a sum of the emission cost estimate for each of the set of components; or
both.

20. The computer program of claim 19, wherein determining the total emission cost estimate comprises determining a first cost of well drilling, a second cost of well completion, a third cost of a facility node in one or more first layers of the production site, a fourth cost of a unit of pipeline length in one or more second layers of the production site, a fifth cost of production per barrel of oil, a sixth cost of production per cubic feet of gas, a seventh cost of processing one or more barrels of produced water, an eighth cost of processing one or more barrels of injected water, or any combination thereof.
